(19) United States
(12) Patent Application Publication
(10) Pub. No.: US 2011/0302897 A1
(43) Pub. Date: Dec. 15, 2011

(54) SWATHGATE WITH ADJUSTABLE CROP GUIDES AND METHOD OF CROP DISTRIBUTION

(76) Inventors: CURTIS HOFFMAN, Manheim, PA (US); Edward A. Blakeslee, Ephrata, PA (US)

(21) Appl. No.: 12/813,964

(22) Filed: Jun. 11, 2010

(51) Int. Cl. A01D 57/00; A01D 43/00

(52) U.S. Cl. 56/192

(57) ABSTRACT

A crop guide apparatus having a plurality of angularly positionable guide fins projecting generally perpendicularly from a mower-conditioner swathgate into the crop discharge stream as it exits the conditioner apparatus whereby the angular position of the fins influences the lateral direction of a portion of the crop discharge stream and allows the resultant crop stream to laterally convergently or laterally divergently directed. The adjustable guide fins are connected to and extend from the working surface of the swathgate generally perpendicular to the plane of the swathgate. Angular position of the each guide fin may be fixed using a pinned or bolted connections to one of a plurality of holes in the swathgate, or an actuator mechanism may be incorporated to pivot the guide fins on the pivot axes, preferably in a coordinated manner. The crop guide apparatus enables crop cutting, conditioning, and tedding to be performed in a single pass by a single machine.

### BACKGROUND OF THE INVENTION

This invention relates generally to harvesting machines, such as mower-conditioners, of the type having a swathgate to influence the trajectory of the crop material being discharged from the header, and, more particularly, to a swathgate having adjustable guides enabling lateral control over the trajectory of the discharged crop material compared to a conventional swathgate.

Current practice in hay and grass harvesting is to cut a relatively wide swath of the crop within a range of anywhere between 10 and 16 or more feet in width, condition the crop, and then consolidate the crop into a narrower, substantially continuous windrow, in which form the conditioned crop is left to dry in the field until the moisture content has been reduced to a value suitable for subsequent harvesting operations, such as baling. Crop flow is directed using a combination of shields, guides, and deflectors positioned to act upon the crop material as it is discharged from the conditioner mechanism and direct the crop material to a desired arrangement on the ground. Known shields, guides, and deflectors typically interface with the outer periphery of the discharged crop stream and are intended to generally converge the crop stream into a narrower windrow than the width of the conditioner from which the crop flow is discharged.

It is desirable in some circumstances to disperse crop material to enhance drying rather than to gather the crop into a windrow. This approach is especially beneficial when harvesting green crops with higher moisture content, typically around 80%. Known side shields and deflectors acting on the outer periphery of the discharge stream of crop exiting a conditioner are limited in that once fully retracted, no further action upon the crop discharge stream is possible. Thus, such mechanisms can spread crop on the ground only up to the discharge width of the conditioner mechanism. Further retraction of such shields will not cause further dispersion of the discharge crop mat. As conditioner mechanism widths are generally on the order of half the cutting width of a harvester, significant crop consolidation occurs during a conventional mowing and conditioning pass.

It would be desirable to provide a crop guide apparatus working in conjunction with the swathgate or other discharge shields in a mower conditioner that acts on more than the outer periphery of the crop discharge stream and allow divergent dispersion of the discharge crop material that would overcome the above problems and limitations. The benefits are magnified by the crop guide apparatus producing a resultant crop mat substantially wider than the conditioner discharge width up to the full cutting width of the machine. Further benefits would be realized by crop guide apparatus that is easily adjustable thereby enabling the degree of crop dispersion to be optimized for the particular crop being harvested. Still further benefits would be realized by a crop guide apparatus that is easily incorporated into current production mower-conditioners without significant alteration of the machine design.

### SUMMARY OF THE INVENTION

Accordingly, the present invention, in any of the embodiments described herein, may provide one or more of the following advantages:

It is an object of the present invention to provide a guide mechanism for application on a mower-conditioner swathgate having one or more guide fins projecting into the crop discharge stream that allow lateral deflection of a portion of the crop discharge stream.

It is another object of the present invention to provide one or more angularly adjustable guide fins projecting into the crop discharge stream of a mower-conditioner to laterally deflect a portion of the discharge flow stream along a desired trajectory that differs from the trajectory of the crop discharge stream.

It is a further object of the present invention to provide angularly adjustable guide fins on a mower-conditioner swathgate that enable the crop material discharge stream to be laterally convergently or laterally divergently directed by interaction with the guide fins.

It is a further object of the present invention to provide a one or more guide fins on a mower-conditioner swathgate that may be used with or without downstream crop shields.

It is a still further object of the present invention to provide an adjustable crop guide mechanism for use on a mower-conditioner swathgate that is durable in construction, inexpensive of manufacture, carefree of maintenance, easily assembled, and simple and effective to use.

These and other objects are achieved according to the instant invention by providing angularly adjustable guide fins projecting generally perpendicularly from a mower-conditioner swathgate into the crop discharge stream as it exits the conditioner apparatus whereby the angular position of the fins influences the lateral direction of a portion of the crop discharge stream and allows the resultant crop stream to laterally convergently or laterally divergently directed. The adjustable guide fins are pivotally connected to the swathgate along an axis generally perpendicular to the plane of the swathgate. Angular position of the each guide fin may be fixed using a pinned or bolted connection to one of a plurality of holes in the swathgate, or an actuator mechanism may be incorporated to pivot the guide fins on the pivot axes, preferably in a coordinated manner.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a side elevation view of a typical pull-behind agricultural harvester having a cutting and conditioning mechanism of the type on which the present invention is useful;

FIG. 2 is a plan view of the mower-conditioner of FIG. 1 showing the crop flow through the machine and the present invention;

FIG. 3 is a partial elevation view of a swathgate showing one embodiment of the angularly adjustable guide fin of the present invention;

FIG. 4 is a partial plan view of the swathgate and guide fins shown in FIG. 3;

FIG. 5 is partial elevation view of the swathgate of FIG. 3 showing a second embodiment of the angularly adjustable guide fins of the present invention; and

FIG. 6 is a partial plan view of the swathgate and guide fins shown in FIG. 5.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience, and are determined by standing at the rear of the machine facing in its normal direction of travel. Likewise, “forward” and “rearward” are determined by the normal direction of travel. “Upward” and “downward” orientations are relative to the ground or operating surface as are any references to “horizontal” or “vertical” planes. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all of the figures.

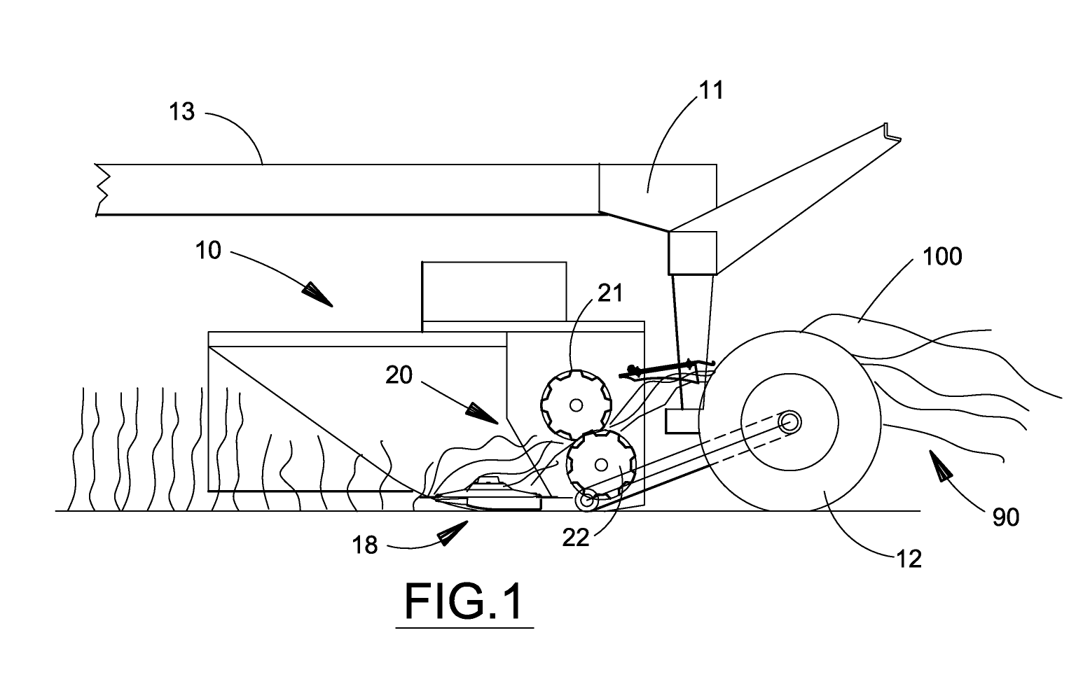

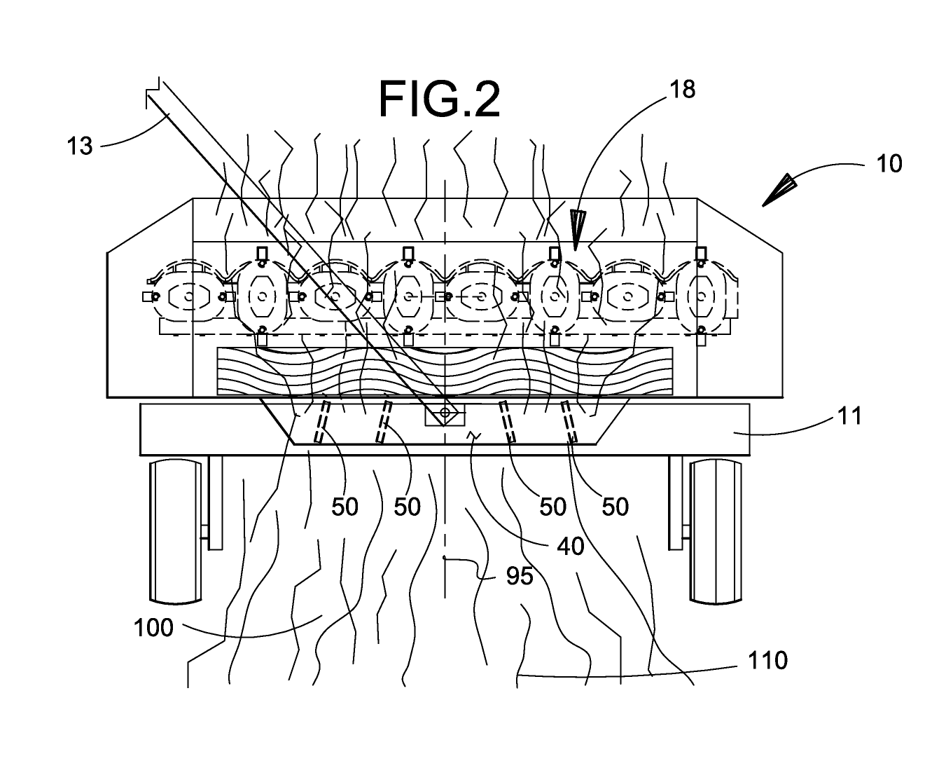

FIGS. 1 and 2 show side and top views of a conventional pull-behind agricultural mower-conditioner 10 used for cutting and conditioning a standing crop 1 as it travels forwardly across the ground. The mower-conditioner 10 is supported by a frame 11 which is operably connected to a tractor (not shown) and supported by a pair of trailing wheels 12 (only one shown). The frame 11 is configured to raise and lower the mower-conditioner relative to the ground surface to support mowing and transport operations. The crop 1 is severed from the ground by a transversely disposed cutting apparatus 18 whereupon it is centrally converged and engaged by a conditioning mechanism 20. The conditioning mechanism 20 may comprise a pair of transversely elongate conditioning rolls 21, 22 as shown, or it may comprise a flail-type conditioner in which crop passes between a single roll with radially arranged flails and a closely proximate adjacent surface in order to crush the crop material. Conditioning rolls 21, 22 are closely spaced apart on parallel, transverse axes such that a gap is created therebetween through which severed crop material 1 passes. The severed and conditioned crop material 100 is then ejected rearwardly from the conditioner rolls 21, 22 in an airborne stream 90 along a trajectory whereupon it falls to the ground.

Mower crop cutting widths are generally on the order of 10 to 15 feet, though greater widths are often employed in the interest of harvesting efficiency. In a typical arrangement, the conditioner mechanism width is less than the cutting width, and can be as little as half of the cutting width. In mowing operations in which cutting and windrowing in a single machine pass is desired, the crop is converged between the cutting mechanism conditioner to reduce the lateral span of the crop. Shields acting upon the outer periphery of the discharged stream of crop material further influence the lateral trajectory of the airborne crop to urge the crop into a more laterally compact windrow. Such shields may include side shields for influencing the width of the resultant windrow and a swathgate for influencing the height of the crop trajectory. However, such shields are limited in that they act only upon the outer periphery of the crop stream and therefore are capable only of converging crop direction.

In the present invention, swathgate 40 comprises a generally planar crop guide oriented generally above the crop trajectory ejected from conditioner rolls 21, 22. Pivot axle 42 is oriented transverse on the mower-conditioner 10 and to the crop stream trajectory 90. The transverse pivot allows the swathgate 40 to be angularly adjusted to deflect the flow of crop material being discharged from the conditioner rolls 21, 22 for optimal placement behind the mower-conditioner. Most swathgates are manually angularly adjusted to the desired crop trajectory based upon the crop being harvested and the spatial relationship between the conditioner rolls and the ground for the nominal header operating height on level ground. Once set, the swathgate is typically not moved while the machine is operating.

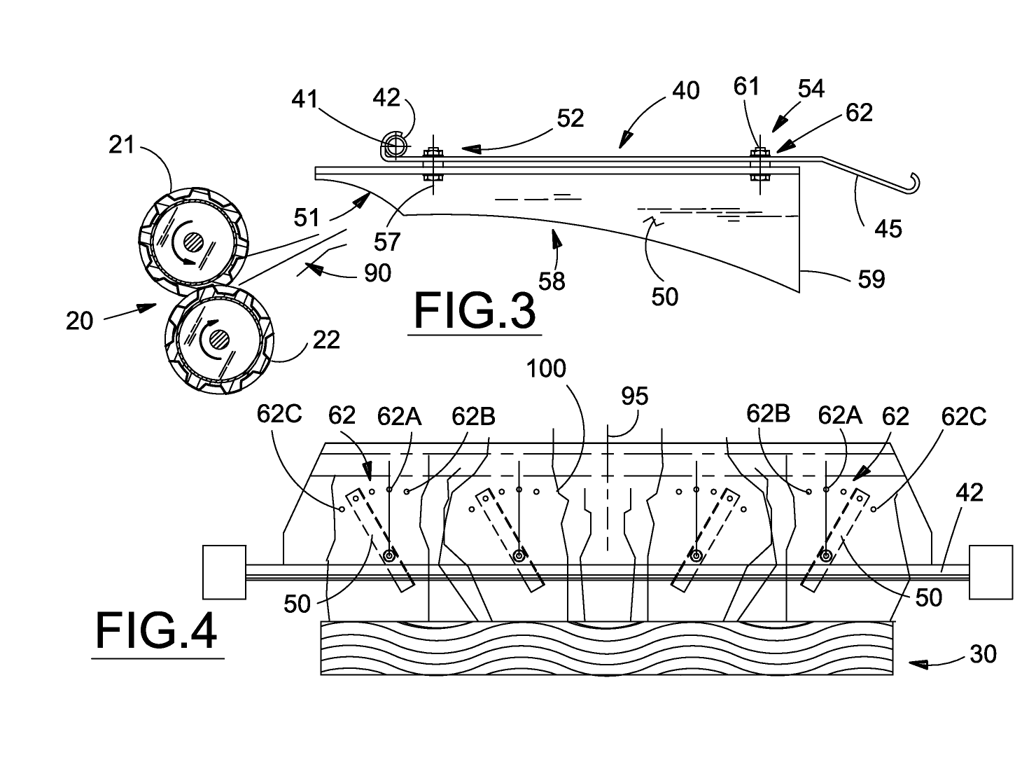

Referring now to FIGS. 3 and 4 in conjunction with FIGS. 1 and 2, the swathgate 40 on the mower-conditioner 10 includes one or more elongate crop guide fins 50 which are movably connected to the swathgate by a pivot 52. Each guide fin 50 is a generally planar structure that is substantially perpendicularly oriented to the plane of the swathgate and includes a leading edge 51, a tail end 59, and an interface edge 58. Each guide fin projects from the operating surface 45 and extends into the stream of crop material being discharged from the conditioner mechanism during operation. The degree of projection into the crop stream is sufficient to influence the lateral trajectory of a portion of the crop discharge stream. Leading edge 51 and interface edge 58 are configured to avoid protrusions that could prevent crop material from passing along the length of the guide fin. Interface edge 58 is arcuately shaped for a progressively increasing extension into the crop stream along the length of the guide fin. Pivot 52 allows the guide fins 50 to be angularly adjusted about a generally upwardly oriented guide axis 57 thereby changing the angle of the guide fins 50 relative to the direction of the crop material discharged from the conditioner mechanism, shown as crop discharge trajectory 90.

As illustrated in FIGS. 2 and 4, guide fins 50 are angled to disperse the crop discharge stream 90, that is, to produce a crop mat 110 behind the machine that is substantially wider than the conditioner mechanism width. It is preferable for the crop mat 110 width to be approximately the same as the width of the cutting apparatus and have a generally uniform depth across the width. In this manner, the present invention enables a single harvesting machine to cut the crop, condition the crop, and disperse the conditioned crop evenly behind the machine (also called tedding) in a single pass.

The number and placement the guide fins on the swathgate may also be varied based on characteristics of the mower. In the embodiment shown in FIGS. 1 through 4, two pairs of laterally symmetrical guide fins are shown. Swathboards having two guide fins have also been shown to provide the desired utility. Embodiments having more than four guide fins are also permissible as are embodiments having different numbers of guide fins on opposite lateral sides (e.g., three on one side of the longitudinal centerline 95 and two on the opposite). In alternate embodiments, the lateral positioning of the pivots 52 may be altered to displace one side further from the longitudinal centerline 95 that the opposite side, and the spacing between adjacent guide fins need not be uniform from side to side.

The guide fins 50 are held in position by adjustment means 54 to secure the guide fins in fixed angular position about pivot 52. In one embodiment, retention means comprises a bolt 61 or pin engaging the guide fin 50 and one of a plurality of receptacles 62 in the swathgate 40. The positioning of receptacles 62 along an arc centered on pivot 52 allows a plurality of pre-determined guide fin angles to be established easing the task of guide fin adjustment. One of the plurality of receptacles provided for each guide fin may be positioned to align the guide fin generally parallel to the crop trajectory, shown as receptacle 62A. One of the plurality of receptacles provided for each guide fin is positioned to align the tail end 59 of the guide fin inwardly of the pivot 52, shown as receptacle 62B, for use in conventional windrowing operations. Aligning fins inwardly causes the guide fins to convergently bias crop flow toward the center of the header and can be used to augment side shields that are typically used for such crop direction. At least one of the plurality of receptacles provided for each guide fin is positioned to align the tail end 59 of guide fin outwardly of the pivot 52, shown as receptacle 62C. Multiple outward receptacles are preferably to allow the guide fins to be optimally positioned for the harvesting conditions and mower crop flow characteristics. It is also noted that the angular position of each guide fin may be individually optimized; the group of guide fins provided on the swathgate need not be symmetrically angled. Outward alignment of the guide fins results in a divergent bias to crop flow, reducing density of the resultant crop mat on the ground behind the header compared to mat density discharged from the conditioner mechanism. The divergent alignment is particularly useful when harvesting green crop material when optimal crop drying is desired. The present invention, when configured for divergent crop flow, enables crop cutting, conditioning, and generally uniform distribution across the ground with a single pass of a single machine. The capacity of the guide fins 50 and adjustment means 54 to produce convergent, divergent, or neutral bias in the crop discharge flow allows the present invention to be used on swathgates for a variety of crop materials and eliminates the need to produce separate swathgates for windrowing and tedding.

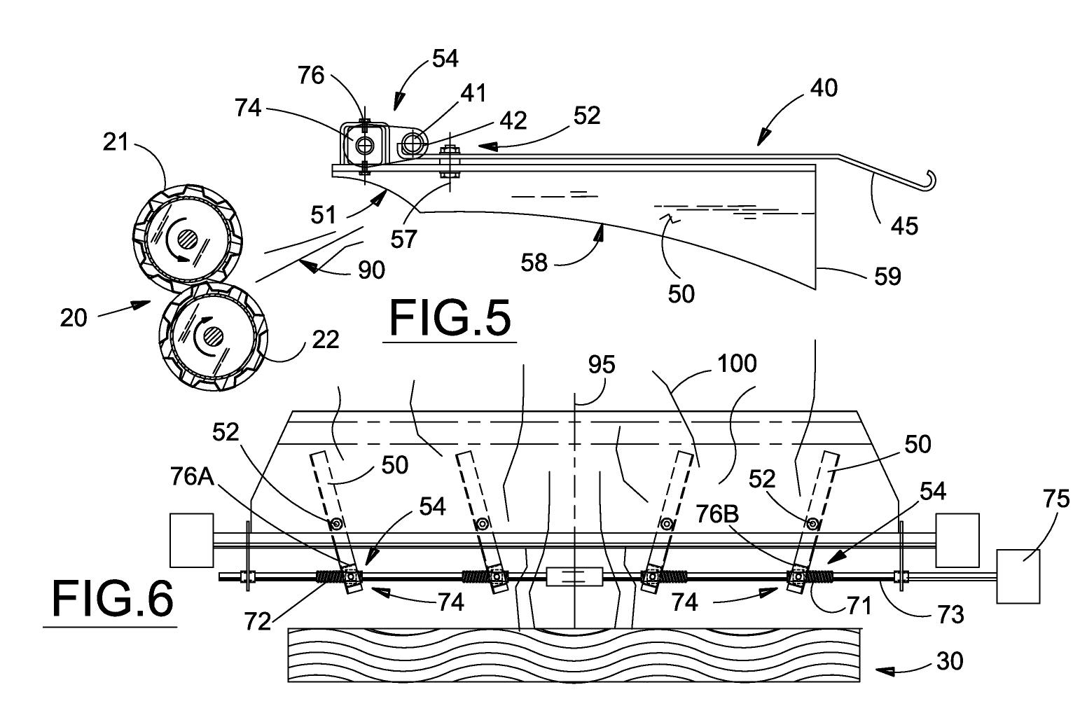

FIGS. 5 and 6 show an alternate embodiment of the guide fin adjustment means 54 in which the manual adjustment means is replaced by an actuator 75 operating a control rod 73 having a pairs of reverse threaded drive screws 71, 72. Drive screws 71, 73 are engaged by nuts 74 which are connected to the guide fins 50 by trunnions 76A, 76B. Control rod 73 is rotated by actuator 75, the rotational movement producing lateral displacement of trunnions 76 through the interaction of the drive screws 71, 72 with nuts 74. The reverse threading of drive screws causes opposite lateral displacement of the trunnions 76A, 76B. The result is that rotation of control rod 73 in a first direction causes inward positioning of the guide fins 50 while rotation of control rod 73 in the opposite direction causes outward movement of the guide fins. Operation of the actuator 75 allows precise adjustment of the guide fin 50 angular position and, with remote control capability of the actuator 75, adjustment of the guide fins while the machine is being operated. It is notes that drive screw pitch may differ between the inboard and outboard connection so that the amount of pivotal movement of the guide fins will differ between the inboard and outboard for a given control rod input rotation. Other power-actuated arrangements capable of pivoting the guide fins 50 are envisioned within the scope of this invention, including actuators in which guide fin positioning is coordinated with swathgate and/or side shield positioning.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A swathgate for directing a flow of crop material discharged from an agricultural mower-conditioner, the mower-conditioner having a transversely disposed cutterbar for severing a swath of standing crop from the ground and a conditioning mechanism rearwardly disposed therefrom for conditioning the severed crop and discharging a stream of conditioned crop, the stream having a discharge width, the swathgate comprising:
a swathgate connected to the header rearward of the conditioner discharge and having a generally planar deflecting surface for interacting with the stream of conditioned crop material; and
first and second guide fin means each being connected to said swathgate and angularly positionable between generally opposing first and second positions about an axis generally perpendicular to said deflecting surface, said first and second guide fin means each have opposing inward and outward working surfaces bounded by an edge, said guide fin means extending generally perpendicularly from said deflecting surface into the crop flow path whereby interaction between said guide fin means and the crop stream enables the crop flow path to be laterally deflected and dispersed in a crop mat on the ground having at least a pre-selected width generally equal to the width of the swath.

2. The swathgate of claim 1, wherein positioning of said first and said second guide fin means in said first position increases a relative proportion of the crop stream interfacing with said outward surfaces thereby increasing the width of the crop stream relative to the discharge width, and positioning of said first and said second guide fin means in said second position increases a relative proportion of the crop stream interfacing with said inward surfaces thereby decreasing the width of the crop stream relative to the discharge width.

3. The swathgate of claim 2, wherein said first and second guide fin means further comprise a position adjustment mechanism enabling selective positioning of said first and second guide fin means in a selected angular position between said first and said second positions, inclusive.

4. The swathgate of claim 3, wherein first and second guide fin means are each pivotally connected to said swathgate and pivotable between generally opposing first and second positions.

5. The swathgate of claim 4, wherein said position adjustment mechanism comprises first and second plurality of receptacles in said swathgate for retaining said first and second guide fins in a pre-selected angular position, respectively, and an engagement device for engaging at least one of said first and second plurality of receptacles, respectively, to angularly fix each said guide fin means in a preselected angular position.

6. The swathgate of claim 4, wherein said first and said second guide fin means each comprise at least one guide fin.

7. The swathgate of claim 3, wherein said position adjustment mechanism comprises a control rod rotatable in opposing first and second directions and having first and second threaded sections, and wherein said first and second guide fins each have a threaded receptacle engaging said first and second threaded sections, respectively, rotation of said control rod in said first direction causing pivotal movement of said first and second guide fins toward said first position and rotation of said control rod in said second direction causing pivotal movement of said first and second guide fins toward said second position.

8. The swathgate of claim 7, further comprising an actuator for rotating said control rod in said first or second direction responsive to an operator input.

9. In an agricultural mower conditioner header for a harvesting machine having a crop cutting apparatus disposed on a forward edge of the header for severing a swath of standing crop from the ground, a conditioner mechanism positioned rearwardly therefrom for receiving cut crop material, conditioning the severed crop, and propelling the conditioned crop material in a rearwardly directed airborne stream along a trajectory having a lateral width, the improvement in a crop deflecting swathgate comprising:
a swathgate for interacting with the airborne crop stream to bias the trajectory of the crop stream, said swathgate connected to the header rearward of the conditioner mechanism and having a generally planar deflecting surface for interacting with the crop stream; and
first and second guide fin means each being removably connected to said swathgate and angularly positionable between generally opposing first and second positions about an axis generally perpendicular to said deflecting surface, each said guide fin means having a generally planar structure extending generally perpendicularly from said deflecting surface into the crop stream whereby interaction between said first and second guide fin means and the crop stream enables the crop trajectory to be laterally deflected and dispersed in a crop mat on the ground having at least a pre-selected width generally equal to the width of the swath.

10. The improvement of claim 9, wherein positioning of said first and said second guide fin means in said first position increases the width of the crop stream relative to the discharge width, and positioning of said first and said second guide fin means in said second position decreases the width of the crop stream relative to the lateral width.

11. The improvement of claim 10, wherein said first and second guide fin means are each pivotally connected to said swathgate and pivotable between generally opposing first and second positions.

12. The improvement of claim 11, wherein said first and second guide fin means further comprise a position adjustment mechanism enabling selective positioning of said first and second guide fin means in a selected angular position between said first and said second positions, inclusive.

13. The improvement of claim 12, wherein said position adjustment mechanism comprises first and second plurality of receptacles in said swathgate for retaining said first and second guide fin means in respective pre-selected pivotal positions, and an engagement device on each said guide fin means for engaging one of said first and second plurality of receptacles, respectively.

14. The improvement of claim 13, wherein said first and said second guide fin means each comprise at least one guide fin.

15. The improvement of claim 12, wherein said position adjustment mechanism comprises a control rod rotatable in opposing first and second directions and having first and second threaded sections, and wherein said first and second guide fin means each have a threaded receptacle engaging said first and second threaded sections, respectively, rotation of said control rod in said first direction causing pivotal movement of said first and second guide fin means toward said first position and rotation of said control rod in said second direction causing pivotal movement of said first and second guide fin means toward said second position.

16. The improvement of claim 15, further comprising an actuator for rotating said control rod in said first or second direction responsive to an operator input.

17. A method for cutting, conditioning, and directing a discharge flow of crop material discharged from an agricultural mower-conditioner, the mower-conditioner having a transversely disposed cutterbar for severing a swath of standing crop from the ground and a conditioning mechanism rearwardly disposed therefrom for conditioning the severed crop and discharging a stream of conditioned crop along an airborne trajectory, the stream having a discharge width, the method comprising the steps of:
providing a swathgate for interacting with the airborne crop stream to bias the trajectory of the crop stream, the swathgate being rearwardly disposed of the conditioner mechanism and having a generally planar deflecting surface;
providing first and second guide fin means each being connected to the swathgate and selectively angularly adjustable about an axis generally perpendicular to the deflecting surface between generally opposing first and second positions, the guide fins extending generally perpendicularly from the deflecting surface into the crop flow path;
operating the mower-conditioner in a manner to sever the standing crop, condition the severed crop, and discharge the airborne crop stream from the conditioner mechanism whereupon the stream interacts with the swathgate; and
positioning the first and the second guide fin means in respective first positions wherein interaction between the crop stream and the guide fin means increases the width of the crop stream relative to the discharge width and disperses the crop in a mat on the ground having at least a pre-selected width generally equal to the width of the swath.

18. The method of claim 17, further comprising the steps of:
providing a position adjustment mechanism enabling selective positioning of the first and second guide fin means in one of a plurality of selected pivotal positions between the first and the second positions, inclusive; and
positioning the first and second guide fins each in one of the selected pivotal positions to selectively pre-determine the width of the crop mat.

19. The method of claim 18, wherein the first and said second guide fin means each comprise at least one guide fin.

20. The method of claim 19, wherein the first and second guide fin means are each pivotally connected to the swathgate and pivotable between generally opposing first and second angular positions.
